(19) United States
(12) Patent Application Publication
(10) Pub. No.: US 2020/0334649 A1
(43) Pub. Date: Oct. 22, 2020

(54) SYSTEM AND METHOD FOR PAYING AND RECEIVING GRATUITIES

(71) Applicant: EZ-Tip LLC, Perkasie, PA (US)

(72) Inventor: Erol Veznedaroglu, Perkasie, PA (US)

(21) Appl. No.: 16/852,062

(22) Filed: Apr. 17, 2020

Related U.S. Application Data
(60) Provisional application No. 62/836,524, filed on Apr. 19, 2019.

(51) Int. Cl. G06Q 20/10; G06Q 40/02; G06Q 20/32; G06Q 20/40; G06Q 20/38; G06Q 40/00; G06Q 20/08; G06Q 30/02; G06K 7/14; G06K 7/10; G06F 3/0482; G06F 3/0488

(52) U.S. Cl. CPC G06Q 20/108; G06Q 40/02; G06Q 20/3276; G06Q 20/3263; G06Q 20/4014; G06Q 20/383; G06F 3/04883; G06Q 20/085; G06Q 30/0282; G06Q 30/0203; G06K 7/1417; G06K 7/10722; G06F 3/0482; G06Q 40/125

(57) ABSTRACT

A method, system and apparatus provide customizable management for processing electronic payment between parties including gratuities. In particular, the method, system and apparatus provide for communicating financial transaction data across diverse entities without requiring geographical limitations quickly and efficiently using electronic devices while maintaining unique identifiers at each entity for protecting the identity of any particular person. The present invention enables multiple parties to share gratuities and other payments in a non-cash, non-contact, manner in which a user can allocate according to settings or provide payments through payroll systems to distribute gratuity proceeds.

### CROSS-REFERENCE TO RELATED APPLICATION(S)

This application claims priority to, and the benefit of, co-pending U.S. Provisional Application 62/836,524, filed Apr. 19, 2019, for all subject matter common to both applications. The disclosure of said provisional application is hereby incorporated by reference in its entirety.

### FIELD OF THE INVENTION

The present invention relates to integrated payment systems and methods suitable for efficient, identity-protecting, cash-less, and contact-less payment transaction management between multiple distinct entities with no geographic constraints or limitations. A method, system and apparatus provide customizable management for processing electronic payment between parties including gratuities. In particular, the method, system and apparatus provide for sharing financial transaction data across diverse entities quickly and efficiently using electronic devices while maintaining unique identifiers at each entity for protecting the identity of any particular person. The present invention enables multiple parties to share gratuities and other payments in a coordinated, non-cash manner, in which a user can allocate according to settings or provide payments through payroll systems to distribute gratuity proceeds.

### BACKGROUND

Generally, with the advent of electronic forms of payment and the associated ease of use and safety, cash is being used and carried less frequently by many members of the public as a form of payment. Cash contains a mixture of cotton and linen, and correspondingly, it has characteristics of cloth rather than paper. Cash has been identified as a potential carrier of bacterial contamination, changing hands typically a daily basis with a lifespan of approximately five years, thus posing a potential source of virus transmission. Although paying for simple purchases has become exceedingly easy and convenient using electronic payment systems, the ability of such payment systems to readily and easily accommodate paying and receiving gratuities as a recognition of good service (“tipping”) has not been feasible or logistically practical to date. This is particularly true when tipping an individual for performed services is not associated with a more substantial underlying transaction (e.g. a meal, hotel stay). As a result, it forces one to continue to carry at least small amounts of cash in a range of denominations. Not having this cash in the proper denominations leads to embarrassment on the part of the potential tipper (“customer”), should the customer choose not to give a tip as a result (e.g. having only a $20.00 bill when wanting to give a $2.00 tip). There is corresponding anger on the part of the person who feels justified to receive the tip (“recipient”), but is now left empty-handed with no financial remuneration to show for recipient's efforts. Electronic payment system technology experiences other shortcomings including an inability to coordinate gratuity splitting or sharing between multiple parties responsible for gratuity receipt as well as an inability for employers or other business users to properly track and manage small payment and gratuity allocations to ensure equitable distribution to appropriate parties at appropriate intervals. The present improved electronic payment system, embedded with software operative to employ a both web-based and cellular phone accessible application, creates a win-win situation for all parties in a transaction: the customer can instantly tip anywhere and anytime with just a cellphone or computer, for example, in the correct amounts without the need to carry cash, thereby avoiding embarrassment and recognizing good service, and the recipient or employer thereof is able to receive monetary compensation immediately for good service, thereby increasing wages and quality of living for the recipient while improving tracking and management of services performed and gratuities or payments received.

The need for this functionality in an electronic payment system can be represented by the service personnel found in, for example, a hotel. The many service personnel that a guest may interact with during a stay may include, for example, car valets, baggage porters, housekeepers, concierges and bartenders, each of whom a hotel guest may wish to provide with tips (formerly delivered in cash) for the associated services that are acceptably rendered. The system and method for payment of such gratuities provided by the system (or EZ-TIP™) application provides the hotel guest with a means for the unobtrusive, secure and immediate payment of such tips while maintaining anonymity, if desired, for both the customer and recipient. Further, the hotel guest is able to tip for good service even when the person providing the service is not present for a face-to-face interaction (e.g. a housekeeper typically cleans the customer's hotel room when the customer is not present so as not to interfere and be unobtrusive). In this instance, the customer may not tip the housekeeper (due to an “out-of-sight, out-of-mind” lapse in action), but by utilizing the present system, the customer can tip the recipient after the service has been provided, thereby rewarding good service and enhancing compensation for the housekeeper. In addition to the tip, the system and method provided by the system application can also be configured to allow the user to provide feedback, comments or reviews specific to the tip recipient or to the service in general.

### SUMMARY

There is a need for a method, system and apparatus that provides trackable, customizable management for processing electronic payment between parties including gratuities. In particular, the method, system and apparatus provide for communicating financial transaction data across diverse entities quickly and efficiently using electronic devices while maintaining unique identifiers at each entity for protecting the identity of any particular person or entity. The present invention enables multiple parties to share gratuities and other payments in a coordinated, non-cash manner in which a user can allocate payment management according to settings or provide payments through payroll systems to distribute gratuity proceeds. The present invention is directed toward further solutions to address this need for secure device-to-device payment that can be tracked, managed and re-allocated, in addition to having other desirable characteristics. The invention is a technological improvement over existing electronic payment systems at least because at initiation, the application operating on a customer mobile electronic device accesses the device imaging native utility, application, or software controlling the function of the imaging device to focus and capture a scanned image of machine-readable code. This enables a customer to point the associated camera or other imaging device at a recipient's displayed unique identification code and capture the appropriate data in an automatic identification and data capture (AIDC) similar to, but faster and more reliably than mobile check deposit or remote deposit capture as known in the art that enables deposit of a check into a bank account by taking a picture of it with a smartphone or tablet. The automatic identification and data capture (AIDC) unique identifier is then parsed by the application, recognized by comparison to existing data in databases. The system transmits appropriate data for each registered party to the transaction from previously saved settings such that the appropriate account or payment service for each customer is selected and the appropriate financial transaction is initiated by customer selection in a few presses or swipes, without the need of searching for an individual recipient, exchanging personally identifying information (i.e., can be anonymous), or operating the same payment service application. The recipient's previously saved settings permits the customer's tip to be electronically deposited into the recipient's desired account. The invention is a practical application of imaging and payment technology that enables not only increased speed and efficiency in allowing a customer to direct a payment to a recipient without the exchange of physical cash or personal or financial information, but also enables a business user to manage transfers and allocate proceeds from a payment including gratuity payments, to a collection of individuals according to recorded rules selected by the business user such that a payment from a single customer can be directed to multiple recipient parties responsible for the service for which the payment was provided in a manner that enables the business user to track performance metrics of recipients based on the transactions.

In accordance with example embodiments of the present invention, a system for managing coordinated payments comprises at least a computer, memory and electronic communications network operating an application. A customer electronic device is configured for receiving input and using the application. The customer electronic device comprises an optical scanning device for scanning and recognizing a machine-readable code comprising an automatic identification and data capture (AIDC) unique identifier, corresponding to, and displayed by, at least one recipient entity; and one or more graphical user interface (GUI) active screens configured for receiving, from a user, an input of customer that activates the payment application on the customer electronic device. The system, using the application, progresses through a series of verifications confirming that the unique identifier corresponds to a registered recipient entity or group of recipients and then provides a verification page displaying signifying information. GUI active screens comprise at least a payment screen on which the customer designates a value using direct entry or pressing assorted amount buttons or percentage buttons. Customer input fields enable a customer to provide comments transmitted to one or more of the business user or the at least one recipient entity. A pay button presented to the customer enables the approval of a payment wherein tapping or swiping initiates a predetermined funds transfer sequence from a customer payment source to a payment destination corresponding to a business user operating the application and/or a recipient entity payment destination, using setup parameters for methods of payment previously entered by one or more of the customer, business user or recipient entity. The system transmits, using one or more displays and the electronic communications network, a message regarding payments made and received and provides periodic updates to a history of transactions to each of the customer, the business user and the at least one recipient entity. The business user uses the system, comprising a database, to collect data from the customer regarding use of the application or relative performance of the at least one recipient entity and provide individual or collective payment to the at least one recipient entity.

In accordance with aspects of the present invention, the payment can be a gratuity or tip intended for the at least one recipient. The system can provide secure and immediate payment while maintaining anonymity of the customer and the at least one recipient entity with respect to each other.

In accordance with aspects of the present invention, the business user can be the at least one recipient entity or an employer of the at least one recipient entity, and the at least one recipient entity can be one or more service employees of the business user.

In accordance with aspects of the present invention, the AIDC unique identifier can comprise a bar code of one or more dimensions including a QR code displayed on one or more of a badge, pin, sticker, business card, receipt, or claim check. The AIDC unique identifier can enable the customer, via prompt, to establish an account, should an account have not been previously established, thereby enhancing the efficiency of the system and easy adoption of associated benefits of the system. The customer can then subsequently make payments or tip for services provided in a time-delayed fashion. The customer can activate a scanning function with a right swipe or tap on the customer electronic device. The assorted amount buttons or assorted percentage buttons of the GUI active screens including the payment screen can comprise a default gratuity in a single button or a cumulative gratuity using multiple buttons and designate a current total gratuity provided for verification purposes. The payment options can be customized by one or more of the business user, the customer, or the at least one recipient to provide one or more of a list of suggested payment amounts, a list of suggested payment percentages, and/or a customer input field, each displayed on the customer electronic device to the customer.

In accordance with aspects of the present invention, the system can enable the business user to provide gratuities to the at least one recipient entity through a normal payroll system or other means the business user utilizes.

In accordance with aspects of the present invention, the customer electronic device can comprise one of a smart phone, tablet, computer or similar computing device. The AIDC unique identifier can comprise a non-visual identification. The system can be operated using both a web-based and cellular phone accessible application. One or more of the customer, business user or at least one recipient entity can register with the system and acquire the application.

In accordance with aspects of the present invention, a predetermined funds transfer sequence from a customer payment source to a payment destination can comprise one or more of a credit card account, a debit card account, or bank account, a banking application, payment application, or a method of payment tied to a direct payment method or direct deposit to an existing account controlled by, or associated with, either the customer or the at least one recipient entity.

In accordance with aspects of the present invention, the system can collect data and feedback from the customer regarding use of the application or relative performance of the at least one recipient entity at time of payment or other designated period. The system can enable the business user to seek response from the customer regarding service and/or the at least one recipient entity providing service using specific inquiries or surveys. The collective payment using the system can comprise calculating the amount of the gratuity or tip to be given by the business user, with multiple payment values directed to a plurality of recipient entities comprising a group of recipients registered collectively with the application or a group of recipients assigned by the business user.

In accordance with aspects of the present invention, the AIDC unique identifier can be scanned by the optical scanning device of the customer electronic device and saved in a database, enabling the customer electronic device to pay a gratuity to the at least one recipient entity at a later period.

In accordance with aspects of the present invention, the customer electronic device can initiate a predetermined funds transfer sequence based on retained information that the customer intended to perform a payment or tip to the at least one recipient entity presented to the customer device to perform a time-delayed funds transfer sequence for a payment transaction for a payment or tip for services provided at an earlier period.

In accordance with aspects of the present invention, the system can perform payment transactions remotely, using an image or electronic capture of the AIDC unique identifier acquired by the optical scanning device of the customer electronic device while it resides at a location geographically separated and remote from a physical location of the AIDC unique identifier displayed by the at least one recipient entity.

In accordance with example embodiments of the present invention, a method for managing coordinated payments includes a system operating an application using a computer, memory and electronic communications network. A customer electronic device receives from a user or customer an input activating the application on the customer electronic device. Graphical user interface (GUI) active screens of the application receive, from a user or customer, commands initiating a transaction; an optical scanning device scanning and recognizing a machine-readable code comprising an automatic identification and data capture (AIDC) unique identifier, corresponding to, and displayed by, at least one recipient entity; and the system progresses through a series of verifications using the application and confirming that the unique identifier corresponds to a registered recipient entity or group of recipients and then providing a verification page displaying signifying information. GUI active screens prompt the customer with a list of suggested payments and the customer designating on a payment screen a value using direct entry with input fields and/or pressing assorted amount buttons or percentage buttons to enter a default or cumulative payment value. The customer verifies intended recipient and amount presented on the GUI active screens and approves payment by tapping or swiping a pay button, initiating a predetermined funds transfer sequence from a customer payment source to a payment destination corresponding to a business user operating the application and/or a recipient entity payment destination, using setup parameters for methods of payment previously entered by one or more of the customer, business user or recipient entity. The system transmits, using one or more displays and the electronic communications network, a message regarding payments made and received and/or periodic updates to a history of transactions to each of the customer, the business user and the at least one recipient entity. The business user uses the system, comprising a database, to collect data from the customer regarding use of the application or relative performance of the at least one recipient entity and provide individual or collective payment to the at least one recipient entity.

### BRIEF DESCRIPTION OF THE FIGURES

These and other characteristics of the present invention will be more fully understood by reference to the following detailed description in conjunction with the attached drawings, in which:

FIG. 1 is an example illustrative chart of the system for implementing a process of optimizing payment by activating the application and scanning a recipient entity displayed unique QR code and designating tip amount and initiate payment;

FIG. 2 is an example illustrative chart of the system for implementing a process of optimizing payment by activating the application, scanning a code and using a recipient's employer to disperse funds to the recipient via payroll transactions;

FIG. 3 is an example illustrative chart of the system for implementing a process of optimizing payment to a group of recipients registered collectively using the recipients' employer to allocate and disperse funds to the recipient via payroll transactions;

FIG. 4 is an example illustrative chart of the system for implementing a process of optimizing payment to a group of recipients using a separate payment application, a banking institution, and employer payroll cooperatively in transactions;

FIG. 5 is an example illustrative chart of the system for implementing a process of optimizing payment to a group of recipients using a separate payment application only for collective payment;

FIGS. 6A, 6B, and 6C are example illustrative diagrams of system GUI active screens displayed on customer smart phones or electronic devices for scanning and recognition of QR codes, verification, and payment selection;

FIGS. 7A, 7B, and 7C are example illustrative diagrams of GUI active screens displayed on customer smart phones or electronic devices to designate and calculate the total value of a payment;

FIGS. 8A, 8B, and 8C are example illustrative diagrams of GUI active screens of customer smart phones or electronic devices for login and scanning of QR codes;

FIGS. 9A, 9B, 9C and 9D are example illustrative diagrams application download, registration and set up;

FIGS. 10A, 10B, and 10C are example illustrative diagrams of GUI active screens of customer electronic devices for menu navigation and financial account set up;

FIGS. 11A, 11B, and 11C are example illustrative diagrams of GUI active screens of customer electronic devices for account history review, filtering and reporting;

FIGS. 12A, 12B, and 12C are example illustrative diagrams of GUI active screens of customer electronic devices for menu navigation, balance transfers and settings;

FIGS. 13A and 13B are example illustrative diagrams of GUI active screens of customer electronic devices for payment transaction management and reporting;

FIG. 14 is an illustrative flow chart of a method according to an exemplary embodiment of the present invention; and

FIG. 15 is a schematic diagram illustrating customer computing or electronic device components according to an exemplary embodiment of the present invention.

### DETAILED DESCRIPTION

An illustrative embodiment of the present invention relates to a method, system and apparatus that provide customizable management for processing electronic payment between parties including gratuities. In particular, the method, system and apparatus provide for sharing financial transaction data across diverse entities quickly and efficiently using electronic devices while maintaining unique identifiers at each entity for protecting the identity of any particular person. The present invention enables multiple parties to share gratuities and other payments in a non-cash manner in which a user can allocate according to settings or provide payments through payroll systems to distribute gratuity proceeds.

Each potential recipient (or group of recipients) registered with the system application (such as, e.g., the EZ-TIP™ application offered by EZ-Tip LLC of Pennsylvania) will be assigned a unique visual identifier, for example, a Quick Response Code (“QR Code”) which is the trademark for a type of two-dimensional barcode first designed in 1994 for the automotive industry in Japan. A QR code consists of black squares arranged in a square grid on a white background, which can be read by an imaging device such as, for example, the camera built into cellular phones, and processed until the image can be appropriately interpreted. The required data, in this application a unique identifier for each recipient(s), is extracted from patterns that are present in both horizontal and vertical components of the image. Other potential means of unique identification applicable to this invention can include, for example, Automatic identification and data capture (AIDC) techniques such as radio frequency identification (RFID). These potential recipients may choose to promote or advertise their participation in the system application by displaying their unique visual identifier (e.g. a QR code) on, for example, an employee badge, lapel pin, sticker, business card, receipt, claim check, or other display means that would be readily accessible to the customer(s) of the service being provided for both identifying the recipient and prominently indicating the recipient's participation in the system to the customer.

The customer activates the system application on a smart phone or other suitable device and immediately scan the recipient's associated QR code. Once the QR code is recognized as being associated with a registered system recipient, the customer is presented with a variety of options for deciding or calculating the amount of the gratuity to be given. The payment options presented can be customized by customer, the recipient(s) and/or the recipient's employer to provide, for example, a list of suggested payment amounts, a list of suggested payment percentages and/or a customer input field. The payment screen may also include secondary identifying information to aid the customer in verifying the intended recipient including, for example, the recipient's name “Bob,” an image of the recipient, or other signifying image. Should the customer desire to tip a recipient and the customer does not currently have an system account, scanning the recipient's QR code triggers a prompt to the customer which allows that customer to establish a system account. The customer can then, subsequently, tip the recipient for services provided.

Once the customer has made the necessary verification and/or selections of the amount of the gratuity, approving the gratuity payment initiates payment from a credit card, debit card or bank account controlled by, or associated with, the customer to a debit card or bank account controlled by, or associated with, the recipient(s). Both the customer and the recipient(s) receive messages regarding payments made and received using the system, thereby providing a history of tips given and/or tips received. The system is flexible and provides the ability for the same unique individual to be able to both give tips and to receive tips as well.

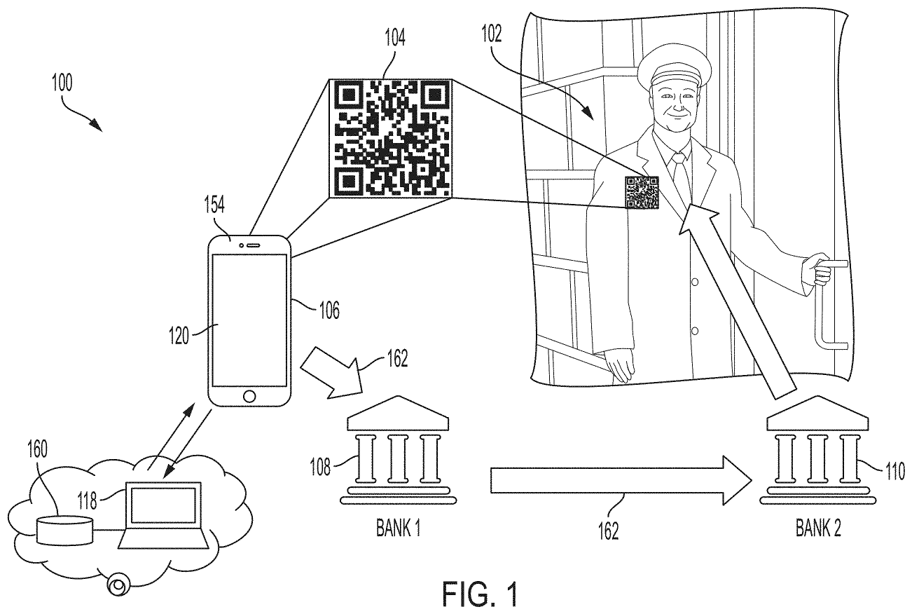

FIGS. 1 through 15, wherein like parts are designated by like reference numerals throughout, illustrate an example embodiment or embodiments of a system and coordinating method for customizable management of electronic payment between parties including gratuities enabling anonymous or collectively allocated payment, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 is an example illustrative chart of the system 100 for implementing a process of optimizing payment by activating the application 120 and scanning a recipient entity 102 displayed unique QR code 104 and designating a payment or tip amount and initiating payment. As illustrated in FIG. 1, in a first example embodiment of the system 100, the recipient 102, in this instance a doorman, has registered with the system 100 and has been assigned a unique QR code 104 that can be displayed on a uniform (shown), incorporated into a name tag (not shown), provided at the doorman's station (not shown) and/or displayed in another manner readily visible and accessible to the customer. The customer simply activates the system application 120 on, for example, a smartphone 106 (using e.g. a graphical user interface (GUI) to acquire input) and scans the unique QR code 104 using an imaging device 154 connected to, integral to, or residing within the smartphone (or similar electronic device) 106. Once the system 100 confirms, that, for example, the scanned QR code 104 corresponds to a registered recipient 102, by transmitting and receiving confirmation data over an electronic communications network 162 from a processor 118 of the system 100 using data stored in a database 160 or similar storage known in the art (including cloud-based storage and processing), the application 120 progresses through a series of verifications (optional) and a payment screen on which the customer designates the payment or tip amount (or percentage) and initiates payment from, for example, a first banking institution 108 associated with the customer to a second banking institution 110 associated with the recipient entity 102 through which the funds are made available to the recipient 102. Both the customer and the recipient 102 shall receive periodic updates regarding gratuity payments made and received so as to have a history of transactions.

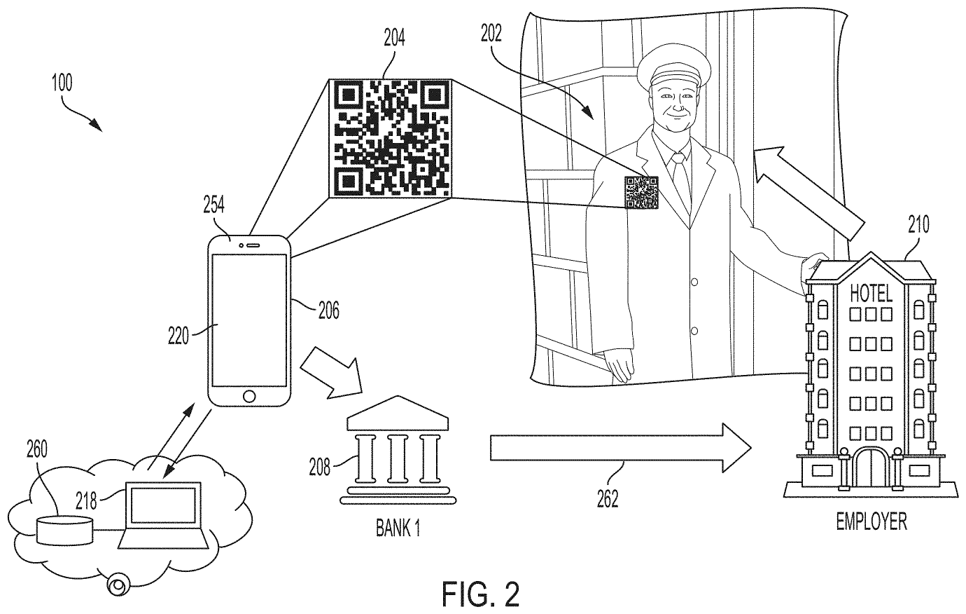

FIG. 2 is an example illustrative chart of the system 100 for implementing a process of optimizing payment by activating the application 220, scanning a code 204 and using a recipient's 202 employer 210 to disperse funds to the recipient 202 via payroll transactions. As illustrated in FIG. 2, in a first example embodiment of the system 100, the recipient 202, in this instance a doorman, has registered with the system 100 and has been assigned a unique QR code 204 that can be worn on uniform (shown), incorporated into a name tag (not shown), provided at the doorman's station (not shown) and/or displayed in another manner readily visible and accessible to the customer. The customer activates the system application 220 on, for example, a smartphone 206 and scans the QR code 204 using imaging device 254 of the electronic device 206. Once the system 100 confirms, by transmitting and receiving confirmation data over an electronic communications network 262 from a processor 218 of the system 100 using data stored in a database 260 or similar storage known in the art, that the scanned QR code 204 corresponds to a registered recipient 202, the application 220 progresses through a series of verification (optional) and a payment screen on which the customer designates the tip amount (or percentage) and initiates payment from, for example, a first banking institution 208 associated with the customer to the recipient's 202 employer 210, such as a residential management company or hotel chain associated with the recipient. The gratuities may then be provided to the recipient 202 through the normal payroll system or via any other means the employer chooses to utilize. Each of the customer, recipient's 202 employer 210 and recipient entity 202 shall receive periodic updates regarding gratuity payments made and received so as to have a history of transactions.

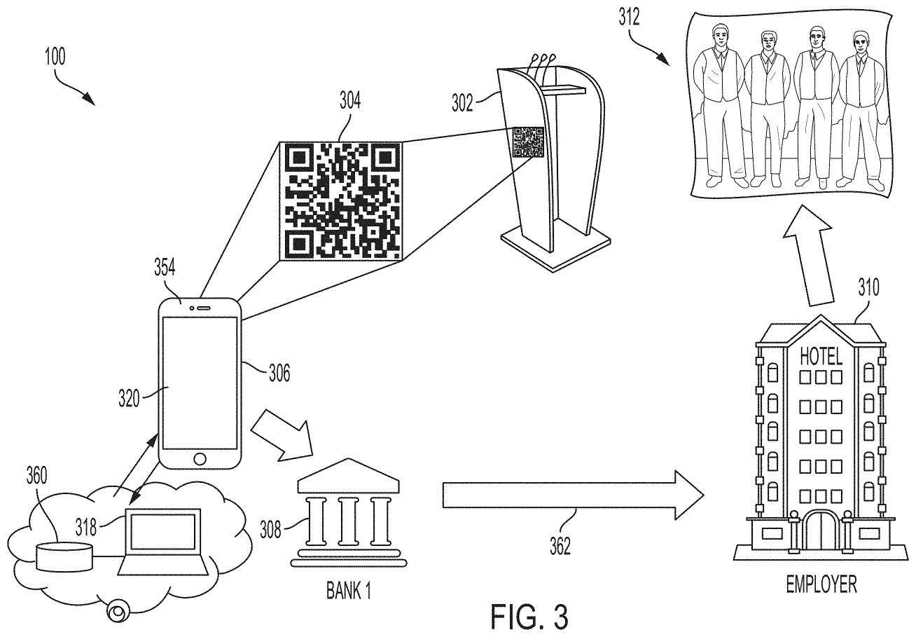

FIG. 3 is an example illustrative chart of the system 100 for implementing a process of optimizing payment to a group of recipients 312 registered collectively using the recipients' 312 employer 310 to allocate and disperse funds to the recipients 312 via payroll transactions. As illustrated in FIG. 3, in a third example embodiment of the system 100, the recipients 312, in this instance a group of valets, have registered collectively with system and have been assigned a unique QR code 304 that can be worn on uniform (not shown), incorporated into a name tag (not shown), provided at the valets' station 302 (shown) and/or displayed in another manner readily visible and accessible to the customer. The customer simply activates the system application 320 on, for example, a smartphone 306 and scans the QR code 304 using an imaging device 354 of the smart phone 306. Once the system 100 confirms, by transmitting and receiving confirmation data over an electronic communications network 362 from a processor 318 of the system 100 using data stored in a database 360 or similar storage known in the art, that the scanned QR code 304 corresponds to one or more registered recipients 312, the application 320 progresses through a series of verification (optional) and a payment screen on which the customer designates the tip amount (or percentage) and initiates payment from, for example, a first banking institution 308 associated with the customer to the recipients' 312 employer 310, such as a parking service or hotel chain associated with the recipients 312. The gratuities may then be provided to the recipients 312 through the normal payroll system or via any other means the employer 310 chooses to utilize. Both the customer and the recipients 312 receive periodic updates regarding gratuity payments made and received so as to have a history of transactions.

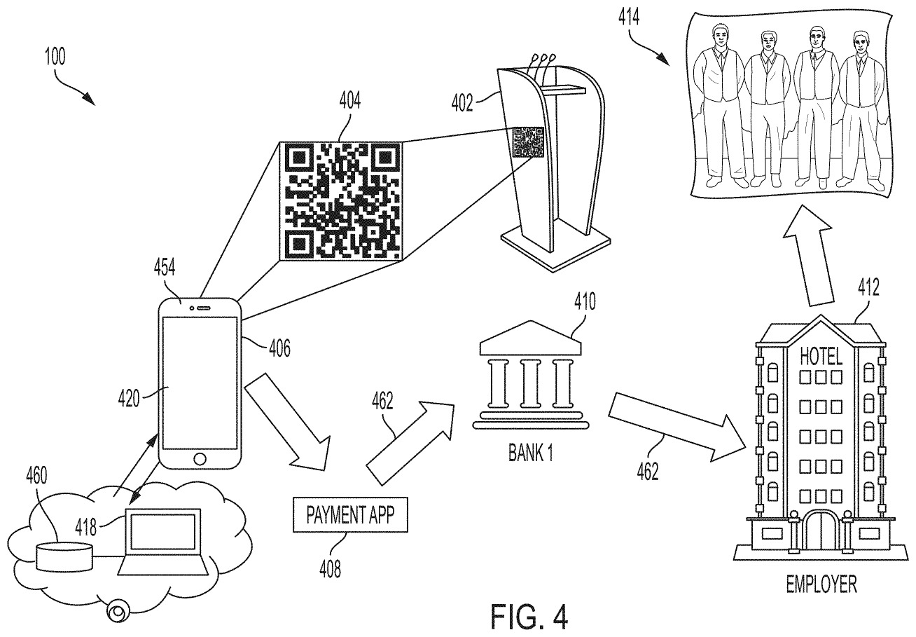

FIG. 4 is an example illustrative chart of the system 100 for implementing a process of optimizing payment to a group of recipients 414 using a separate payment application 408, a banking institution 410, and employer payroll cooperatively in transactions. As illustrated in FIG. 4, in a fourth example embodiment of the system 100, the recipients 414, in this instance a group of valets, have registered collectively with system and have been assigned a unique QR code 404 that can be worn on uniform (not shown), incorporated into a name tag (not shown), provided at the valets' station 402 (shown) and/or displayed in another manner readily visible and accessible to the customer. The customer simply activates the system application 420 on, for example, a smartphone 406 and scans the QR code 404 with an imaging device 454 of the electronic device 406. Once the system 100 confirms, by transferring and receiving confirmation data over an electronic communications network 462 from a processor 418 of the system 100 using data stored in a database 460 or similar storage known in the art, that the scanned QR code 404 corresponds to one or more registered recipients 414, the application 420 progresses through a series of verification (optional) and a payment screen on which the customer designates the tip amount (or percentage) and initiates payment from, for example, a separate payment application 408 such as, for example, Apple Pay™, Google Wallet™, Stripe™, Venmo™, Facebook Messenger™, LoopPay™, Square Cash™, Tilt™, Dwolla™, and others, to a banking institution 410 associated with the recipients' 414 employer 412, such as a parking service or hotel chain associated with the recipients 414. The gratuities may then be provided to the recipients 414 through the normal payroll system or via any other means the employer chooses to utilize. Both the customer, the recipients' 414 employer 412 and the recipients 414 shall receive periodic updates regarding gratuity payments made and received so as to have a history of transactions.

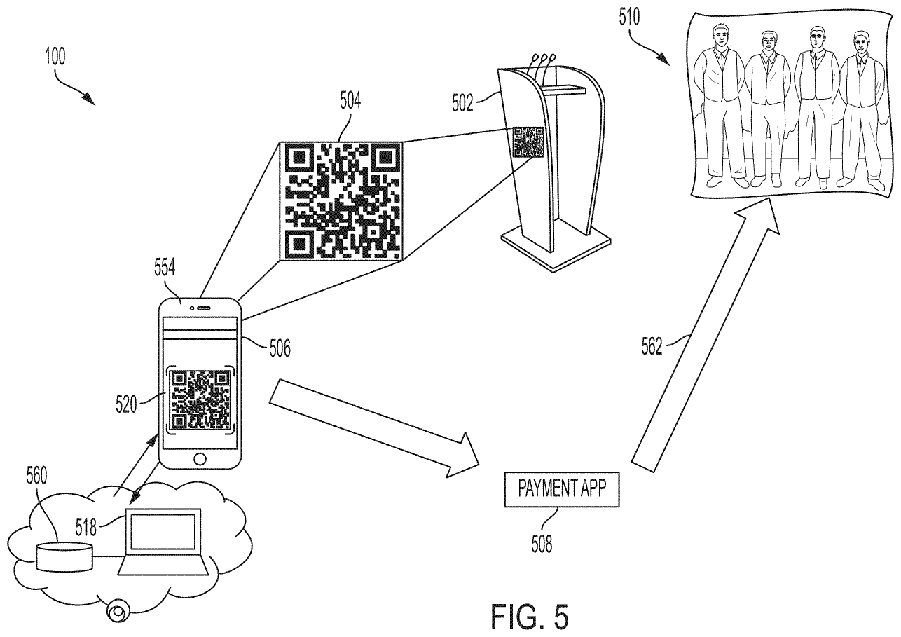

FIG. 5 is an example illustrative chart of the system 100 for implementing a process of optimizing payment to a group of recipients 510 using a separate payment application 508 only for collective payment. As illustrated in FIG. 5, in a fifth example embodiment of the system 100, the recipients 510, in this instance a group of valets, have registered collectively with the system and have been assigned a unique QR code 504 that can be worn on uniform (not shown), incorporated into a name tag (not shown), provided at the valets' station 502 (shown) and/or displayed in another manner readily visible and accessible to the customer. The customer simply activates the system application 520 on, for example, a smartphone 506 and scans, with a native imaging device 554, the QR code 504. Once the system 100 confirms that the scanned QR code 504 corresponds to one or more registered recipients 510, by transferring and receiving confirmation data over an electronic communications network 562 from a processor 518 of the system 100 using data stored in a database 560 or similar storage known in the art (including cloud-based storage and/or processing), the application 520 progresses through a series of verifications (optional) and a payment screen on which the customer designates the tip amount (or percentage) and initiates payment from, for example, a separate payment application 508 such as, for example, Apple Pay™, Google Wallet™, Venmo™, Facebook Messenger™, LoopPay™, Square Cash™ Tilt™, Dwolla™, and others, directly to the recipients 510. Both the customer and the recipients 510 receives periodic updates regarding gratuity payments made and received so as to have a history of transactions. As will be appreciated by those skilled in the art, the examples of payment systems provided above are intended to be illustrative rather than limiting and may be combined, amended, supplemented or replaced with other suitable sequence(s) of fund transfer applications and/or institutions that can be combined to enable the designated transfer of funds from the customer to the recipient 502.

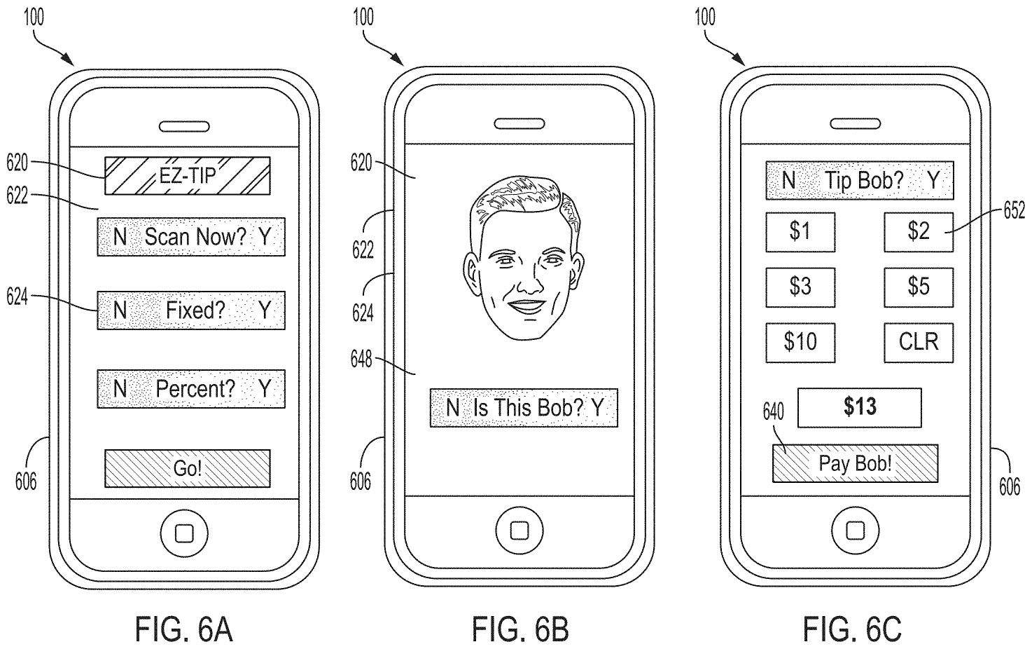

FIGS. 6A, 6B, and 6C are example illustrative diagrams of the system 100 GUI 622 active screens 624 displayed on customer smart phones 606 or electronic devices 606 for scanning and recognition of QR codes 504, verification, and payment selection. As illustrated in FIG. 6A-6C, the system application 620 can be initiated through a number of active screens displayed on the customer's smart phone or other suitable device 606. As shown in FIG. 6A, the customer can activate the scanning function with a right swipe (or other suitable input) into an active screen 624 (e.g. touch screen) of the application 620 GUI 622 operating on the electronic device 606 of the customer and point the associated camera or other imaging device 554 at the recipient's 102 displayed or provided unique QR code 504. Although the visual techniques are being discussed in some detail, those skilled in the art will appreciate that the recipient 102 data can be provided to the customer using non-visual identification techniques such as RFID, so long as the smart phone or other device 606 can be configured to recognize and receive the non-visual signals. Because the system 100 operates in a similar fashion, regardless of the manner in which the recipient 102 identification is received, the disclosure should not be construed as limited to visual identification systems.

The customer may also be afforded an opportunity to select from between fixed amount gratuities or percentage gratuities that may be selected by an appropriate swipe or other suitable input into the GUI 622. Based on the recognition of the unique QR code 504, the system 100 may provide a verification page as shown in FIG. 6B on which is displayed the recipient's 102 photo, name or other designated information or signifying information 648 provided for the purpose of verification. The system 100 is designed to allow the user to proceed anonymously, such that the QR Codes alone can be used to complete the transaction and verify information without ever sharing personally identifying information, simply by selecting an option (e.g. checkbox) presented on the GUI 622.

Once the customer is satisfied that the appropriate person or group has been identified and a fixed amount gratuity selected, the customer is afforded an opportunity to designate the value of the gratuity using either direct entry (not shown) or by using assorted amount buttons as shown in FIG. 6C whereby a default gratuity (single button 640) or a cumulative gratuity (multiple buttons 640) may be designated with the current total gratuity provided for verification purposes. As shown in FIG. 6C, the designated $13 could be entered by pressing, in any sequence, the $10, $2 and $1 buttons. Should the percentage be incorrectly entered, the “C” button may be used to clear the entry for a second attempt. Once the customer is satisfied with the display, tapping or swiping the pay button will initiate the predetermined funds transfer sequence in accordance with the setup parameters previously entered by the recipient 102 and the customer.

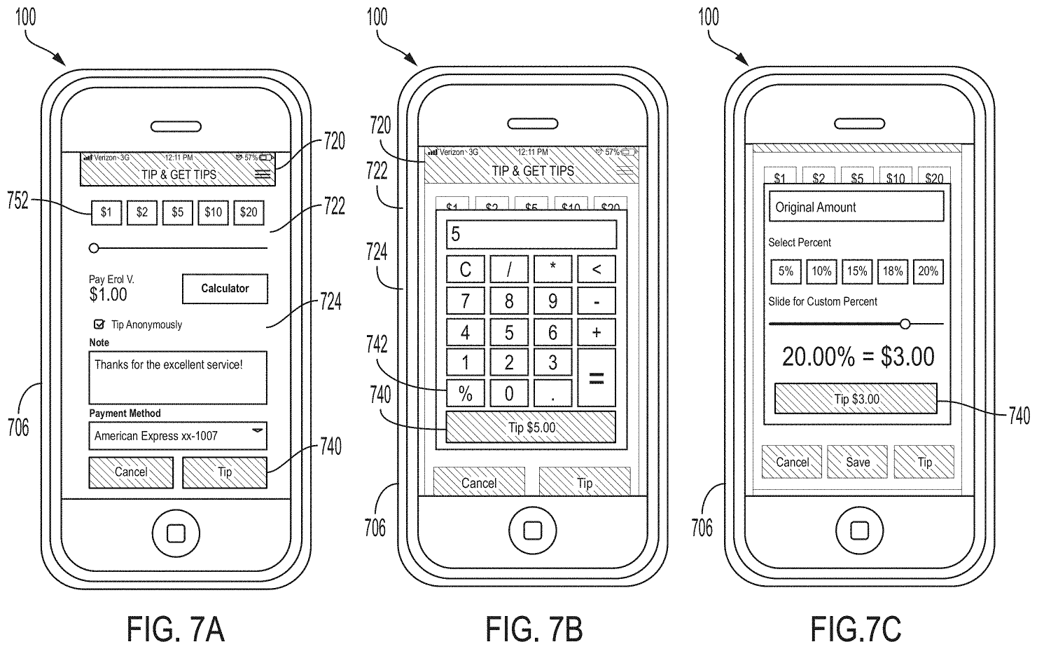

FIGS. 7A, 7B, and 7C are example illustrative diagrams of GUI 722 active screens 724 displayed on customer electronic devices 706 including smart phones to designate and calculate, using e.g. an app-based calculator 742, the total value of a payment. As illustrated in FIG. 7A-7C, the system (e.g. EZ-TIP™) application 720 can be initiated through a number of active screens displayed on the customer's smart phone or other suitable device 706. The customer can activate an imaging device 554 scanning function of an electronic device registered with the system 100 with a right swipe or other suitable input to activate an active screen 724 (known in the art to include e.g. touch screens and various forms of motion capture to operate the GUI 722 of an electronic device 706) and point the associated camera or other imaging device 554 at the recipient's 102 displayed or provided unique QR code 504, for example. Although the visual techniques are discussed in some detail, those skilled in the art will appreciate that the recipient 102 data can be provided to the customer using non-visual identification techniques such as RFID, so long as the smart phone or other device 706 can be configured to recognize and receive the non-visual signals. Because the system 100 operates in much the same regardless of the manner in which the recipient 102 identification is received, the disclosure should not be construed as limited to visual identification systems.

As shown in FIG. 7A, the customer may also be afforded an opportunity to select from between fixed amount gratuities or percentage gratuities that may be selected by an appropriate swipe or other suitable input. Based on the recognition of the unique QR code 504, the system 100 may provide a verification page as shown in FIG. 6B on which is displayed the recipient's 102 photo, name or other designated information provided for the purpose of verification. Alternatively, the system 100 is designed to allow the user to proceed anonymously, such that the QR Codes alone can be used to complete the transaction and verify information without ever sharing personally identifying information, simply by selecting an option (e.g. checkbox depicted in FIG. 7A) presented on the GUI 722.

Once the customer is satisfied that the appropriate person or group has been identified and a percentage amount gratuity selected, the customer will be afforded an opportunity to designate the total value of the tipped amount FIG. 7A, including by activating and performing calculations using an application 720 calculator 742 depicted in FIG. 7B. Additionally, the gratuity percent may be designated using either direct entry (not shown) or by using assorted percentage buttons as shown in FIG. 7C whereby a default gratuity (single button 740) or a cumulative gratuity (multiple buttons 740) may be used designated with the current total gratuity percentage or amount (not shown) being provided for verification purposes. As shown in FIG. 7C, the designated 18% could be entered by pressing one or more buttons 740 (e.g. 18%), of a selectable display of alternatives 752, or by customizing the amount using a slider or other similar selectable GUI element 752. Should the percentage be incorrectly entered, a “C” button may be used to clear the entry for a second attempt. Once the customer is satisfied with the display, tapping or swiping the pay button 740 will initiate the predetermined funds transfer sequence in accordance with the setup parameters previously entered by the recipient 102 and the customer.

In addition to the primary gratuity payment function, the system 100 can be configured to allow the customer to provide comments regarding the service and/or the recipient 102 providing the service. The system 100 may also be configured whereby the recipient 102 and/or a business user comprising the recipient's 102 employer 510 may seek the customer's responses to specific inquires and/or surveys if they so choose.

The method of payment may be tied to a direct payment receipt method at the recipient's 102 choice that are widely available or direct deposit to an existing account. As noted above, a business may utilize the application 720 on behalf of its service employees and provide for the individual or collective payment of gratuities to those employees. A business user can also utilize the system 100 for collecting data regarding the use of the application 720, relative performance of employees and/or solicit evaluations from the customer at the time of payment or at some other designated period. Relative performance metrics may include number of interactions per work period (e.g. hours or work days), number of gratuity transactions per work period, frequency of gratuity transactions, value of gratuity transactions per work period (e.g. minimum, maximum, average or median value), variance or deviation of gratuity transactions, etc.

Businesses that tend to utilize tipped staff include, for example, hotels, salons, restaurants, performance venues, sports venues, convention centers, and bars. Individuals such as, for example, street musicians, performers, and/or buskers could also benefit from an easy and secure way for the appreciative public to reward their performance. A unique system 100 logo can be prominently displayed in connection with the unique QR code 504 or with a designation of the type of non-visual identifier in use at the location to notify the customer/audience of the availability of the system 100 for compensating the service providers/performers.

As used herein, the term QR code 504 or barcode should be understood as referring to any optical, machine-readable, representation of data whether presented in conventional linear or one-dimensional (1D) format comprising a plurality of parallel lines of varying widths and/or spacings and/or data presented in two-dimensional (2D) codes 504 comprising arrangements of rectangles, dots, hexagons and/or other geometric patterns presented in either black and white (B&W) or color.

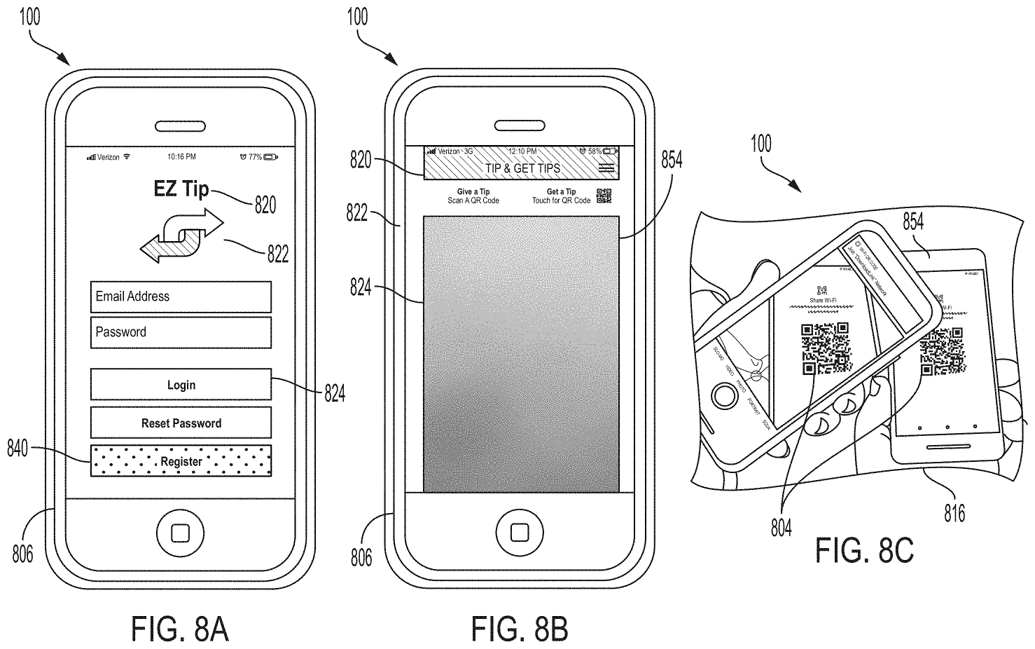

FIGS. 8A, 8B, and 8C are example illustrative diagrams of GUI 822 active screens 824 of customer smart phones 806 or electronic devices 806 for login and scanning of QR codes 804. As implemented on a customer's smart phone or other suitable portable electronic device 806 configured for receiving input from an optical device, e.g., a built-in or external camera or imaging device 854 of the electronic device 806, selecting and activating the system application 820 (e.g. by GUI 822 input) will initiate access to an optical device for scanning and recognizing a machine-readable code 804. The customer can activate the scanning function of an electronic device 806 registered with the system 100 with a right swipe or other suitable input to activate an active screen 824 (known in the art to include e.g. touch screens and various forms of motion capture to operate the GUI 822 of an electronic device 806), wherein the functionality can be accessed quickly and efficiently from a menu or immediately upon initiation of the application 820 operating on the device 806. At initiation, the application 820 accesses the device imaging native utility, application, or software controlling the function of the imaging device 854 to focus and acquire a scanned image of machine-readable code which enables a customer to point the associated camera or other imaging device 854 at the recipient's 102 displayed or provided unique QR code 804 and capture the appropriate data in an automatic identification and data capture (AIDC) similar to, but faster and more reliably than mobile check deposit or remote deposit capture as known in the art that enables deposit of a check into a bank account by taking a picture of it with a smartphone or tablet. The automatic identification and data capture (AIDC) unique identifier represented by the captured unique QR code 804 or similar code is then parsed by the application 820, recognized as system application identifier data and the resulting data is compared to existing data accessed through the system 100 database 160 of the system 100 over an electronic network 162. The system 100, using one or more processors 118, verifies that the detected code 804 corresponds to a registered recipient entity 102, generate one or more displays prompting input/verification from the customer regarding a specified gratuity payment value (or percentage of an associated amount), verifying (or not) the input value, and initiating payment (e.g. by buttons 840 displayed on the active screens 824 of the GUI) of the input payment value to the registered recipient entity 102.

The corresponding system 100 for enabling the system functionality will be accessible to both customers and recipients 102. The system 100 can be configured to receive communications and data from registered users as well as to generate and maintain a database 160 or other registry of the customers and recipients 102 that have downloaded, registered and been authorized to use the system application 820. The registry or database 160 will typically include basic profile information as well as payment, verification, and/or transactional information for facilitating the requested transfer of funds between a customer and one or more gratuity recipients 102. The database/registry may also typically include, at least during a probationary period, authentication information relating at least newly registered users of the system application 820.

As shown in FIG. 8A, each of the system 100 users typically have password-controlled (or access controlled other suitable authentication means) access to and the ability to input, delete, and/or amend certain information regarding their individual (or group) profile as well as, for example, the scope of information (if any) available to other application 820 users, a history 1134 of transactions attempted and/or completed using the application 820 associated with their profile, and a range of payment/receipt/reporting 1138 preferences and designations of associated bank, credit card, debit card or other payment system accounts, whether primary, secondary or tertiary, that can be utilized in effecting the desired payment. If a customer/tipper or recipient/tippee has an system application (i.e. both parties don't already have application), the transaction can still take place. For example, if a recipient/tippee has the application 820, and a customer/tipper doesn't, after the tippee provides good service, the tipper doesn't have resort to cash to tip. The tippee explains possession of the application and displays his unique QR code 804. The tipper can then open a camera function on a cellular phone and take a picture or scan a tippee's unique QR code 804. The system application 820 recognizes tipper doesn't currently have the application 820. An embedded and triggered notification appears to take potential Tipper to a system website or app store. A tipper downloads and registers application at a later time at his or her convenience. Once the tipper is registered for application, the application remembers that tipper intended to tip the tippee from data stored in memory and presents information to perform a delayed tip. The tipper can choose to tip the original tippee or can cancel the tip to the original tippee at this later time. As shown in FIG. 8B, once the application 820 is acquired, registered, and initiated, the GUI 822 presents a viewfinder display to the tipper that enables the imaging device 854 of the tipper's electronic device 806 to be pointed at the QR Code 804 displayed by a tippee's recipient device 816 (FIG. 8C) to scan and recognize that QR code 804 for relevant payment transactions between the respective parties using the system 100.

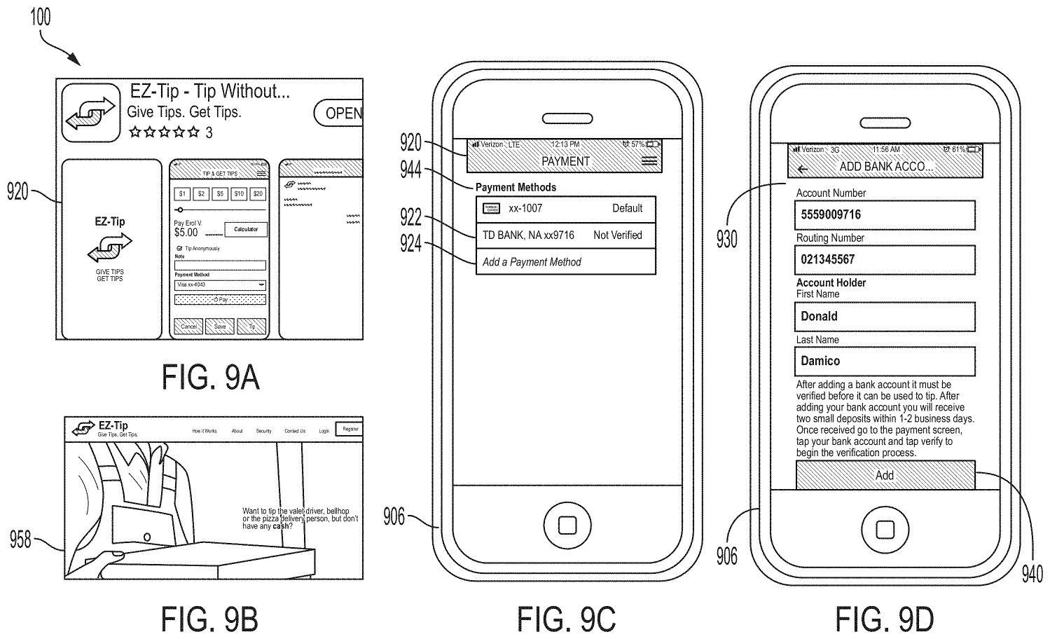

FIGS. 9A, 9B, 9C and 9D are example illustrative diagrams depicting system 100 application 920 download, registration and set up. As shown in FIG. 9, the process to download and register the system application 920 begins as a user navigates to the website 958, an “app store,” or is prompted and linked based on an interaction with a system 100 user. In operation, once the user downloads the application 920, the user may choose to register as a customer/tipper, a recipient entity/tippee, or both. Registration includes entering bank, debit and/or credit account(s) information, payment service provider information, or similar credentials for sending and/or receiving payments or tips. The application 920 can be created for a group of employees (e.g. car wash team) and/or for an entire business 412. The application 920 can be configured to allocate tips received by individuals, departments, etc. The application 920 is created for a unique individual, department or group of employees and a unique QR Code 804 is generated and assigned to the unique individual, department or group of employees. The process proceeds to enable the user to employ an electronic device 906 to register account(s) 930 through input into a GUI 922 with active screens 924 to send (pay) payments or tips, where each individual can register bank, credit card and/or debit card account(s) on the application 920 to send (pay) tips, gratuities or other payments using the registered device 906. A tipper can also use a payment service provider such as Apple PayTM or GooglePayTM in lieu of bank account information. Account 930 information is sent to third-party payment processing company for initial verification (e.g. StripeTM payment processing). Test deposits are generated for bank accounts to confirm. Once third-party payment processing company verifies account(s) 930, it becomes a verified Payment Method to Give a Tip Account(s) 944 and credential that can be updated, deleted, or augmented (including by adding additional payment accounts 944) at any point in time through the system 100 using input fields or buttons 940.

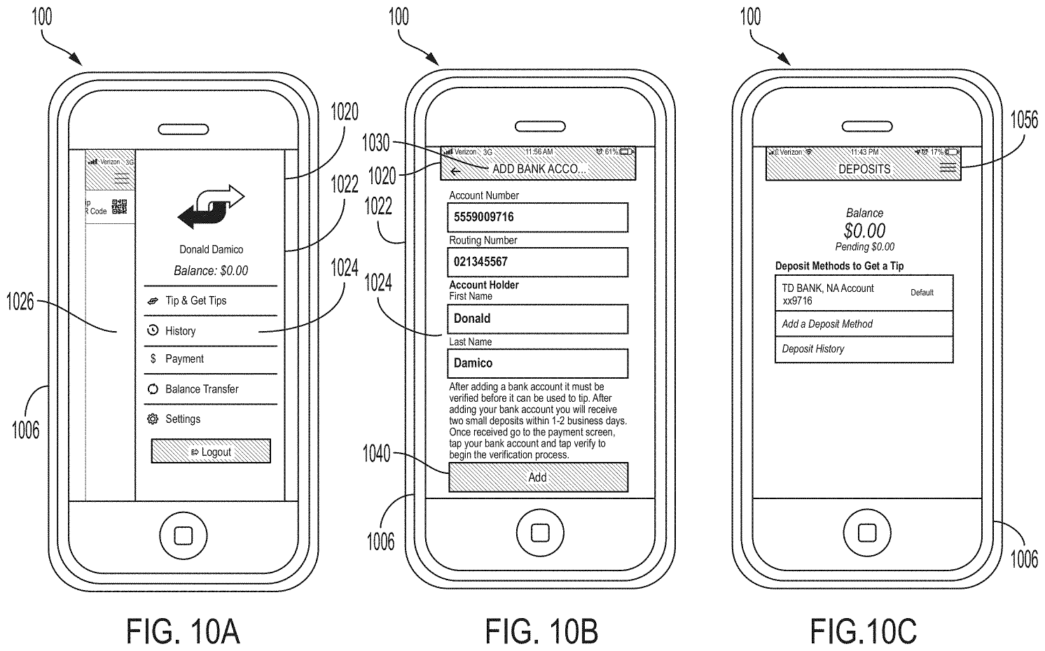

FIGS. 10A, 10B, and 10C are example illustrative diagrams of system 100 GUI 1022 active screens 1024 of customer electronic devices 1006 (running the application 1020) for menu 1026 navigation and financial account 1030 set up. Once the application 920 is created for a unique individual and a unique QR Code 804 is generated and assigned to the individual, the process proceeds enable the user to employ an electronic device 906 to register account(s) 1030 through input into a GUI 922 with active screens 924 to receive (deposit) payments or tips, where each individual can register bank, credit card and/or debit card account(s) on the application 1020 to receive tips, gratuities or other payments using the registered device 1006. An individual registers bank, credit card and/or debit card account on application to receive (deposit) tips or a user can also use a payment service provider such as Apple Pay™ or GooglePay™ in lieu of bank account information. Account 1030 information is sent to third-party payment processing company for initial verification. Test deposits are generated for bank accounts 1030 to confirm. Once third-party payment processing company (e.g. Stripe™) verifies account(s) 1030, it becomes a verified Deposit Method to Get a Tip account(s) 1030 and credential that can be updated, deleted, or augmented (including by adding additional deposit accounts 1056) at any point in time through the system 100 using input fields or buttons 1040.

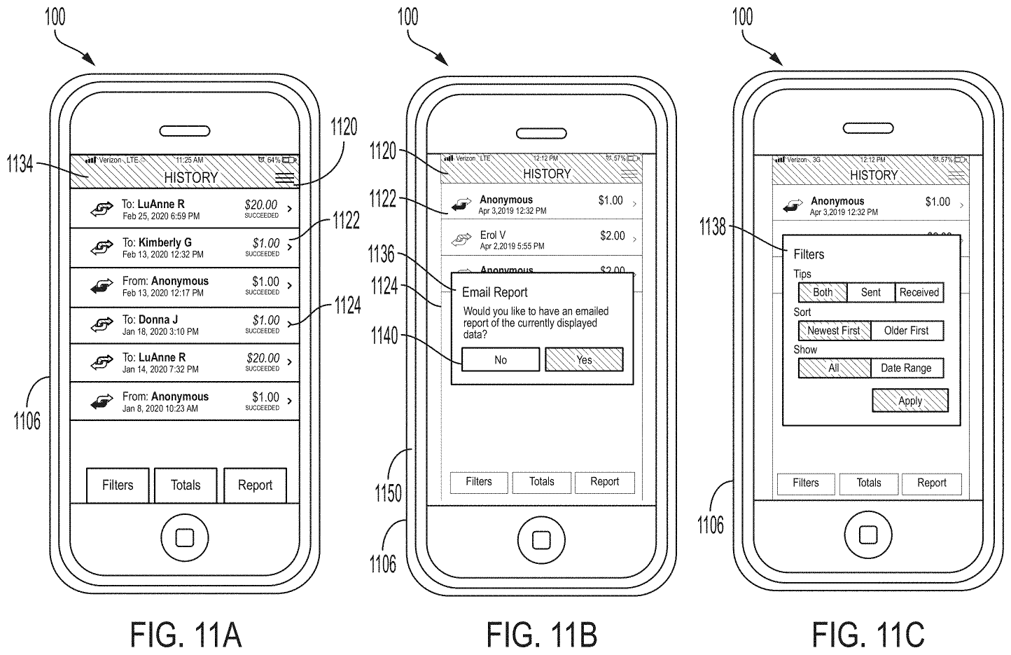

FIGS. 11A, 11B, and 11C are example illustrative diagrams of system 100 GUI 1122 depict active screens 1124 of customer electronic devices for account history 1134 review, filtering 1138 and reporting 1136. In FIG. 11A, a tipper and/or tippee can view tips sent and/or received by selecting a “History” menu 1126 option in the application 1120. The history 1134 enables tip history to be filtered 1138 as shown in FIG. 11B and reports 1136 to be generated as shown in FIG. 11C. Reporting is on-demand and can be generated at business user/group and/or individual level. The application can also incorporate Customer Satisfaction Survey Ratings that can subsequently be averaged, analyzed, etc. and processed as performance metrics available to be analyzed by the business user.

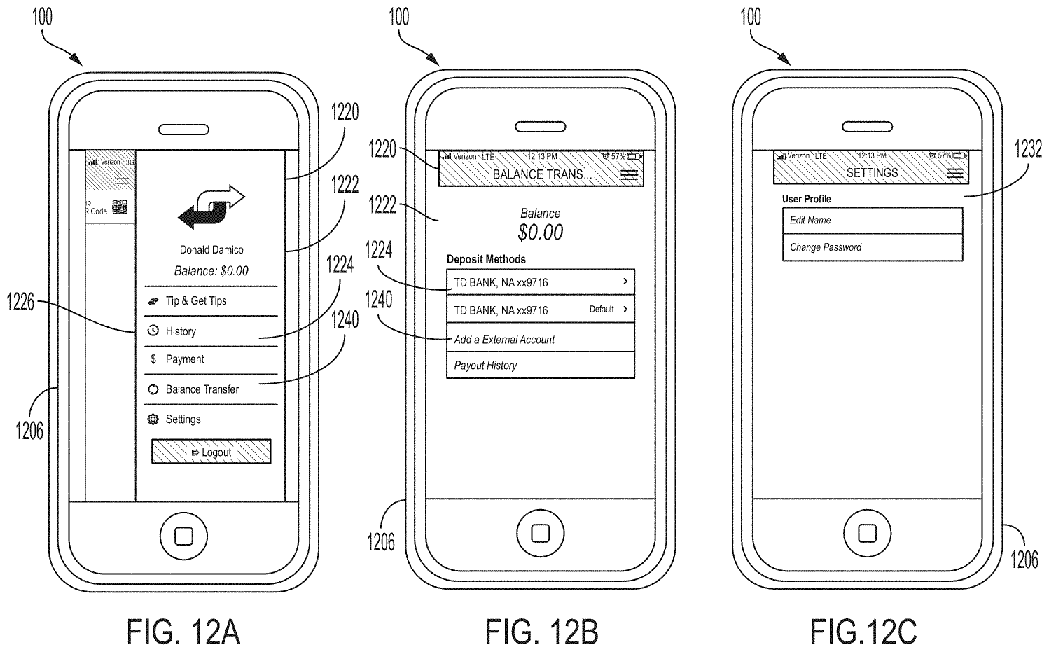

FIGS. 12A, 12B, and 12C are example illustrative diagrams of GUI 1222 active screens 1224 of customer electronic devices 1206 for menu 1226 navigation, balance transfers and input and updating of settings 1232. A customer is enabled by the system 100 to use application 1220 menus 1226 (FIG. 12A) to initiate a balance transfer (FIG. 12B) using input fields and buttons 1240 to transfer amounts between or among accounts registered with the system 100 based on user input settings 1232 (FIG. 12C) that can be entered, stored, adjusted and updated to customize the response of the application 1220 to various user input, allowing for streamlined activation and processing of user commands.

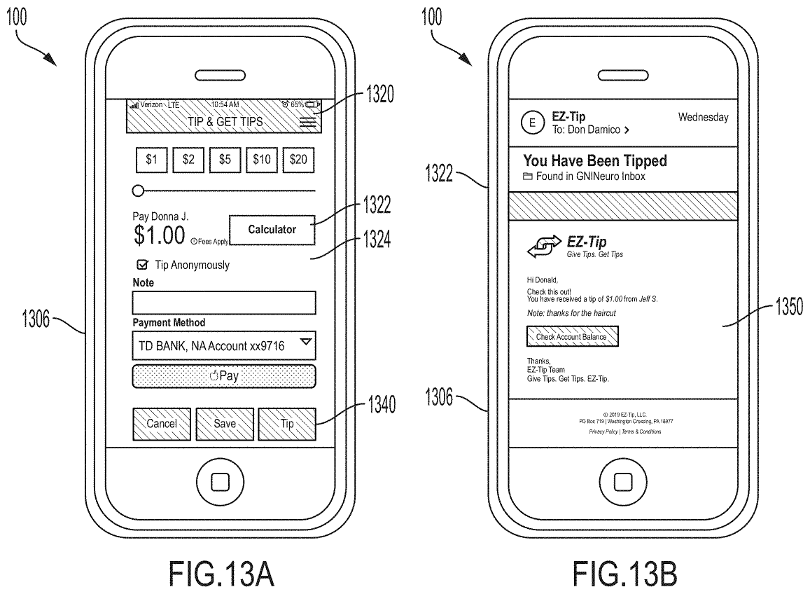

FIGS. 13A and 13B are example illustrative diagrams of GUI 1322 active screens 1324 of customer electronic devices 1306 for payment transaction management and reporting. The system 100 and application 1320 running on a customer device 1306 enable tracking and notification of the process giving a tip and receiving a tip. A tipper cellular phone 1306 captures an image of the code 804 presented on the tippee cellular phone 816. The tipper wants to reward good service provided by the tippee. The tipper opens a system application 1320 and places cellular phone 1306 over tippee's cellular phone 1316 displaying tippee's unique system QR code 804. “TIP & GET TIPS” screen appears and allows the tipper to select amount of tip via one of several methods (tapping on amount, entering amount, using sliding scale or tip “Calculator” 742). The tipper can choose to “Tip Anonymously” and/or can enter a note (e.g. Thanks for good service!) using input fields of the GUI 1322. The tipper confirms a tip amount, taps on a pay button 1340 and the payment transaction is sent to a banking or payment service e.g. Stripe™ for verification. A payment service including Stripe™ confirms payment account and deposit account in conjunction with the system 100. If both are legitimate and not questionable, the financial or payment services or institutions including Stripe™ perform a financial transaction (i.e. debits money from tipper's payment account and credits money to tippee's Deposit account). The system administrator can access 1320 Stripe™ processing account which retains data for all transactions as well as the application stored transaction information. All transactions can be reviewed. A system administrator is also notified for all transactions exceeding a specified threshold (e.g. greater than $20). Email notification 1350 is sent to tippee that the recipient has received a tip and can be reviewed by a business user such as the employer of the tippee recipient entity. System 100 transactions can take place remotely, so no geographic constraints limit the process. The application 1320 does not require person-to-person encounter.

The tipper can send a tip remotely to any tippee—the only requirement is for the tipper to have an image of tippee's unique QR code 804 which can be emailed/texted/printed on a card (e.g. hotel housekeeping staff does not see hotel guests, but can still receive appropriate tips by leaving system cards with printed QR code 804 in hotel guest rooms). The application 1320 will also facilitate tipping the same tippee multiple times using stored data reflecting unique identifiers and prior transactions without the need to perform the entire data acquisition and transaction process. If tipper OR tippee has system application (i.e. both parties don't already have app), a transaction can still take place. For example, tippee has the application, and the tipper does not. The tippee explains application and displays his unique QR code 804. The tipper opens a camera function on cellular phone 1306 and scans tippee's unique QR code 804. The system application 1320 recognizes Tipper doesn't currently have app. A notification appears to take potential tipper to system. Tipper downloads and registers application at a later time at his convenience. Once Tipper is registered for the app, the application 1320 remembers that tipper intended to tip tippee and presents information to perform a delayed tip. The tipper can choose to tip the original tippee or can cancel tip at this later time.

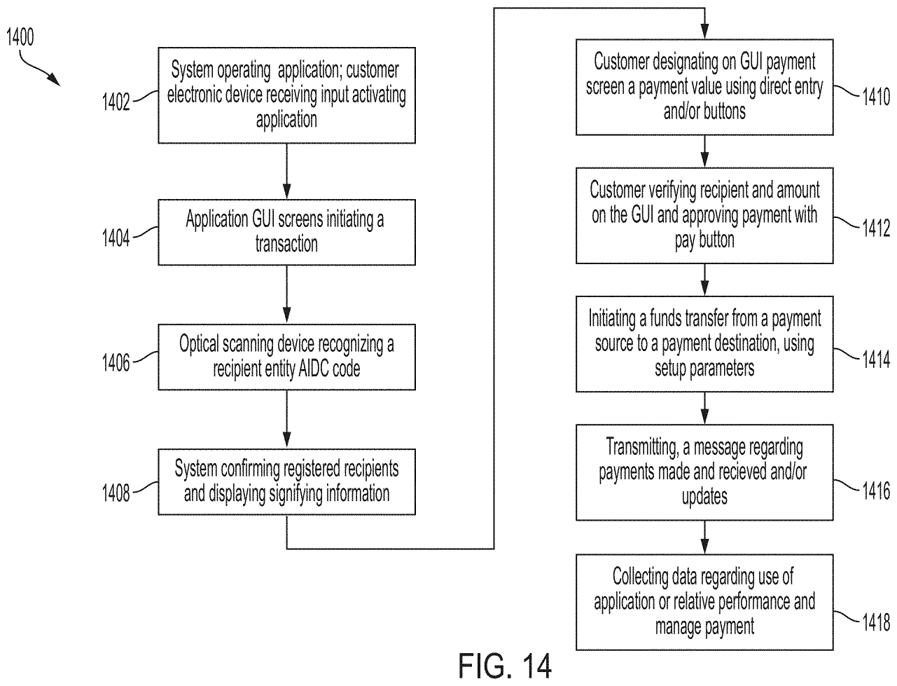

FIG. 14 is an illustrative flow chart of a method 1400 according to an exemplary embodiment of the present invention. The method 1400 for managing coordinated payments commences with a system 100 includes, at Step 1402, operating an application using a computer, memory and electronic communications network. A customer electronic device receives from a user or customer an input activating the application 1320 on the customer electronic device. At Step 1404, graphical user interface (GUI) 1322 active screens 1324 of the application 1320 receive, from a user or customer, commands initiating a transaction. Step 1406, an optical scanning device scanning and recognizing a machine-readable code 804 comprising an automatic identification and data capture (AIDC) unique identifier, corresponding to, and displayed by, at least one recipient entity 102. At Step 1408, the system 100 progresses through a series of verifications using the application 1320 and confirming that the unique identifier corresponds to a registered recipient entity 102 or group of recipients 510 and then providing a verification page displaying signifying information. At Step 1410, the GUI 1322 active screens 1324 prompt the customer with a list of suggested or default payments and at Step 1412, the customer designates on a payment screen a value using direct entry with input fields and/or pressing assorted amount buttons 1340 or percentage buttons 1340 to enter a default or cumulative payment value. At Step 1414, The customer verifies intended recipient 102 and amount presented on the GUI 1322 active screens 1324 and approves payment by tapping or swiping a pay button 1340, initiating a predetermined funds transfer sequence from a customer payment source to a payment destination corresponding to a business user operating the application 1320 and/or a recipient entity 102 payment destination, using setup parameters for methods of payment previously entered by one or more of the customer, business user or recipient entity 102. At Step 1416, The system 100 transmits, using one or more displays and the electronic communications network, a notification message 1350 regarding payments made and received and/or periodic updates to a history 1134 of transactions to each of the customer, the business user 210 and the at least one recipient entity 102. At Step 1418, The business user 210 uses the system 100, comprising a database 160, to collect data from the customer regarding use of the application 1320 or relative performance of the at least one recipient entity 102 and provide individual or collective payment to the at least one recipient entity 102.

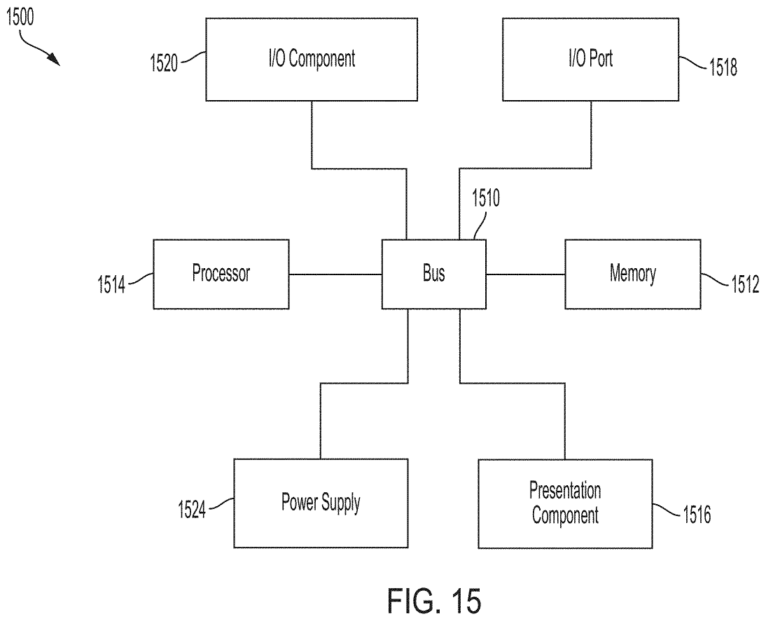

FIG. 15 is a schematic diagram illustrating customer computing or electronic device components according to an exemplary embodiment of the present invention. Any suitable computing device can be used to implement the computing devices 106, 206, 306, 406, 506, 606, 706, 806, 906, 1006, 1106, 1206, 1306, and methods/functionality described herein. Separately operated similar devices may also be used in isolation or multiply linked as in a cloud computing configuration to perform functions of the system 100 processors 118, 218, 318, 418, 518. One illustrative example of such a computing device 1500 is depicted in FIG. 15. The computing device 1500 is merely an illustrative example of a suitable computing environment and in no way limits the scope of the present invention. A “computing device,” as represented by FIG. 15, can include a “workstation,” a “server,” a “laptop,” a “desktop,” a “hand-held device,” a “smartphone,” a “mobile device,” a “tablet computer,” or other computing devices, as would be understood by those of skill in the art. Given that the computing device 1500 is depicted for illustrative purposes, embodiments of the present invention may utilize any number of computing devices 1500 in any number of different ways to implement a single embodiment of the present invention. Accordingly, embodiments of the present invention are not limited to a single computing device 1500, as would be appreciated by one with skill in the art, nor are they limited to a single type of implementation or configuration of the example computing device 1500.

The computing device 1500 can include a bus 1510 that can be coupled to one or more of the following illustrative components, directly or indirectly: a memory 1512, one or more processors 1514, one or more presentation components 1516, input/output ports 1518, input/output components 1520, and a power supply 1524. One of skill in the art will appreciate that the bus 1510 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 15 is merely illustrative of an exemplary computing device that can be used to implement one or more embodiments of the present invention, and in no way limits the invention.

The computing device 1500 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1500.

The memory 1512 can include computer-storage media in the form of volatile and/or nonvolatile memory. The memory 1512 may be removable, non-removable, or any combination thereof. Exemplary hardware devices are devices such as hard drives, solid-state memory, optical-disc drives, and the like. The computing device 1500 can include one or more processors that read data from components such as the memory 1512, the various I/O components 1516, etc. Presentation component(s) 1516 present data indications to a user or other device. Exemplary presentation components include a display device, speaker, printing component, vibrating component, etc.

The I/O ports 1518 can enable the computing device 1500 to be logically coupled to other devices, such as I/O components 1520. Some of the I/O components 1520 can be built into the computing device 1500. Examples of such I/O components 1520 include a microphone, joystick, recording device, game pad, satellite dish, scanner, printer, wireless device, networking device as part of an electronic communications network, and the like.

As utilized herein, the system (100) and method 1400 are all illustrative of the claimed invention. The numbering scheme is utilized to correlate figure number to elements of the invention, not to indicate different components or systems. Likewise, the corresponding other reference numbers for each figure in the numbering scheme begin with a number indicating the figure.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween. It is therefore intended that the protection granted hereon be limited only by the definition contained in the appended claims and equivalents thereof.

What is claimed is:

1. A system for managing coordinated payments, the system comprising:
a computer, memory and electronic communications network operating an application;
a customer electronic device configured for receiving input and using the application, comprising:
an optical scanning device for scanning and recognizing a machine-readable code comprising an automatic identification and data capture (AIDC) unique identifier, corresponding to, and displayed by, at least one recipient entity; and
a graphical user interface (GUI) active screens configured for receiving, from a user, an input of customer that activates the payment application on the customer electronic device;
wherein the system, using the application, progresses through a series of verifications confirming that the unique identifier corresponds to a registered recipient entity or group of recipients and then provides a verification page displaying signifying information;
the GUI active screens comprising:
a payment screen on which the customer designates a value using direct entry or pressing assorted amount buttons or percentage buttons;
customer input fields enabling a customer to provide comments transmitted to one or more of a business user or the at least one recipient entity; and
a pay button presented for approving payment wherein tapping or swiping initiates a predetermined funds transfer sequence from a customer payment source to a payment destination corresponding to a business user operating the application and/or a recipient entity payment destination, using setup parameters for methods of payment previously entered by one or more of the customer, business user or recipient entity;
wherein the system transmits, using one or more displays and the electronic communications network, a message regarding payments made and received and provides periodic updates to a history of transactions to each of the customer, the business user and the at least one recipient entity; and
wherein the business user uses the system, comprising a database, to collect data from the customer regarding use of the application or relative performance of the at least one recipient entity and provide individual or collective payment to the at least one recipient entity.

2. The system of claim 1, wherein the payment is a gratuity or tip intended for the at least one recipient.

3. The system of claim 1, wherein the system provides secure and immediate payment while maintaining anonymity of the customer and the at least one recipient entity with respect to each other.

4. The system of claim 1, wherein the business user is an employer of the at least one recipient entity, and wherein the at least one recipient entity is one or more service employees of the business user.

5. The system of claim 1, wherein the AIDC unique identifier comprises a QR code displayed on one or more of a badge, pin, sticker, business card, receipt, or claim check.

6. The system of claim 1, wherein scanning the AIDC unique identifier enables the customer, via prompt, to establish an account, then subsequently tip for services provided.

7. The system of claim 1, wherein the customer activates a scanning function with a right swipe on the customer electronic device.

8. The system of claim 1, wherein the assorted amount buttons or assorted percentage buttons comprise a default gratuity in a single button or a cumulative gratuity using multiple buttons designated with current total gratuity provided for verification purposes.

9. The system of claim 1, wherein payment options are customized by one or more of the business user, the customer, or the at least one recipient to provide one or more of a list of suggested payment amounts, a list of suggested payment percentages, and/or a customer input field, each displayed on the customer electronic device to the customer.

10. The system of claim 1, wherein the system enables the business user to provide gratuities to the at least one recipient entity through a normal payroll system or other means the business user utilizes.

11. The system of claim 1, wherein the customer electronic device comprises one of a smart phone, tablet, or computer.

12. The system of claim 1, wherein the AIDC unique identifier comprises a non-visual identification.

13. The system of claim 1, wherein the system is operated using a web-based and/or cellular phone accessible application.

14. The system of claim 1, wherein one or more of the customer, business user or at least one recipient entity registers with the system and acquires the application.

15. The system of claim 1, wherein predetermined funds transfer sequence from a customer payment source to a payment destination comprises one or more of a credit card account, a debit card account, or bank account to a debit card or bank account, a banking application, payment application, or a method of payment tied to a direct payment method or direct deposit to an existing account controlled by, or associated with, either the customer or the at least one recipient entity.

16. The system of claim 1, wherein the system collects data and feedback from the customer regarding use of the application or relative performance of the at least one recipient entity at time of payment or other designated period.

17. The system of claim 1, wherein the system enables the business user to seek response from the customer regarding service and/or the at least one recipient entity providing service using specific inquiries or surveys.

18. The system of claim 1, wherein collective payment comprises calculating the amount of a gratuity or tip to be given by the business user, with multiple payment values directed to a plurality of recipient entities comprising a group of recipients registered collectively with the application or a group of recipients assigned by the business user.

19. The system of claim 1, wherein the AIDC unique identifier scanned by the optical scanning device of the customer electronic device is saved in a database, enabling the customer electronic device to pay a gratuity to the at least one recipient entity at a later period.

20. The system of claim 1, wherein the customer electronic device initiates a predetermined funds transfer sequence based on retained information that the customer intended to perform a payment or tip to the at least one recipient entity presented to the customer device to perform a time-delayed funds transfer sequence for a payment transaction for a payment or tip for services provided at an earlier period.

21. The system of claim 1, wherein the system performs payment transactions remotely, using an image or electronic capture of the AIDC unique identifier acquired by the optical scanning device of the customer electronic device while it resides at a location geographically separated and remote from a physical location of the AIDC unique identifier displayed by the at least one recipient entity.

22. A method for managing coordinated payments, the method comprising:
a system operating an application using a computer, memory and electronic communications network;
a customer electronic device receiving from a user or customer an input activating the application;
graphical user interface (GUI) active screens of the application receiving, from a user or customer, commands initiating a transaction;
an optical scanning device scanning and recognizing a machine-readable code comprising an automatic identification and data capture (AIDC) unique identifier, corresponding to, and displayed by, at least one recipient entity;
the system progressing through a series of verifications using the application and confirming that the unique identifier corresponds to a registered recipient entity or group of recipients and then providing a verification page displaying signifying information;
GUI active screens prompting the customer with a list of suggested payments and the customer designating on a payment screen a value using direct entry with input fields and/or pressing assorted amount buttons or percentage buttons to enter a default or cumulative payment value;
the customer verifying intended recipient and amount presented on the GUI active screens and approving payment by tapping or swiping a pay button, initiating a predetermined funds transfer sequence from a customer payment source to a payment destination corresponding to a business user operating the application and/or a recipient entity payment destination, using setup parameters for methods of payment previously entered by one or more of the customer, business user or recipient entity;
the system transmitting, using one or more displays and the electronic communications network, a message regarding payments made and received and/or periodic updates to a history of transactions to each of the customer, the business user and the at least one recipient entity; and
wherein the business user uses the system, comprising a database, to collect data from the customer regarding use of the application or relative performance of the at least one recipient entity and provide individual or collective payment to the at least one recipient entity.
